(19) United States
(12) Patent Application Publication
(10) Pub. No.: US 2017/0102002 A1
(43) Pub. Date: Apr. 13, 2017

(54) FAN SHAFT FOR AIR CYCLE MACHINE

(71) Applicant: Hamilton Sunstrand Corporation, Windsor Locks, CT (US)

(72) Inventors: Craig M. Beers, Wethersfield, CT (US); Seth E. Rosen, Middletown, CT (US)

(21) Appl. No.: 14/880,313

(22) Filed: Oct. 12, 2015

(51) Int. Cl. F04D 29/053; F16C 3/02

(52) U.S. Cl. CPC F04D 29/053; F16C 3/02; F05D 2230/20

(57) ABSTRACT

A fan shaft for an air cycle machine. The fan shaft includes a body having an axis passing therethrough and a pilot at one end of the body, the body having a first axial length, the pilot having a second axial length, and the pilot defining an inner diameter with respect to the axis and an outer diameter with respect to the axis, wherein the first axial length is 4.215±0.005 inches (10.706±0.013 cm).

### BACKGROUND

The subject matter disclosed herein generally relates to air cycle machines and, more particularly, to fan shafts for air cycle machines.

Conventional aircraft environmental control systems incorporate an air cycle machine, also referred to as an air cycle cooling machine, for use in cooling and dehumidifying air for an aircraft cabin. Such air cycle machines may include two or more wheels disposed at axially spaced intervals along a common shaft. The wheels are part of, for example, a compressor rotor, a turbine rotor, a fan rotor, an additional turbine rotor, or an additional compressor rotor. In some cases the turbine or turbines drive both the compressor and the fan.

On aircraft powered by turbine engines, the air to be conditioned in the air cycle machine is typically compressed air bled from one or more compressor stages of the turbine engine. In conventional systems, this bleed air passes through the air cycle machine compressor where it is further compressed. The compressed air is passed through a heat exchanger to cool the compressed air sufficiently to remove moisture and dehumidify the air. The dehumidified compressed air is expanded in the turbine of the air cycle machine to both extract energy from the compressed air so as to drive the shaft and also to cool the expanded turbine exhaust air before it is supplied to the aircraft cabin as conditioned cooling air.

### SUMMARY

According to one embodiment a fan shaft for an air cycle machine. The fan shaft includes a body having an axis passing therethrough and a pilot at one end of the body, the body having a first axial length, the pilot having a second axial length, and the pilot defining an inner diameter with respect to the axis and an outer diameter with respect to the axis, wherein the first axial length is 4.215±0.005 inches (10.706±0.013 cm).

In addition to one or more of the features described above, or as an alternative, a method of making a fan shaft for an air cycle machine, the method includes forming a body having an axis passing therethrough and a pilot at one end of the body, the body having a first axial length, the pilot having a second axial length, and the pilot defining an inner diameter with respect to the axis and an outer diameter with respect to the axis, wherein the first axial length is 4.215±0.005 inches (10.706±0.013 cm).

In addition to one or more of the features described above, or as an alternative, a fan shaft for an air cycle machine, the fan shaft includes a body having an axis passing therethrough and a pilot at one end of the body, the body having a first axial length, the pilot having a second axial length, and the pilot defining an inner diameter with respect to the axis and an outer diameter with respect to the axis, wherein a ratio between the first axial length and the second axial length is between 8.1748 and 9.0753.

Technical effects of embodiments of the present disclosure include an optimized fan shaft for an air cycle machine that may retain proper fan trajectory during a rotor burst. Further, technical effects include a fan shaft configured to minimize stress in a fan shaft during operation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic cross-sectional view of an air cycle machine;

FIG. 2A is a schematic view of a fan shaft in accordance with an embodiment of the present disclosure;

FIG. 2B is a schematic view of a pilot of the fan shaft of FIG. 2A in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

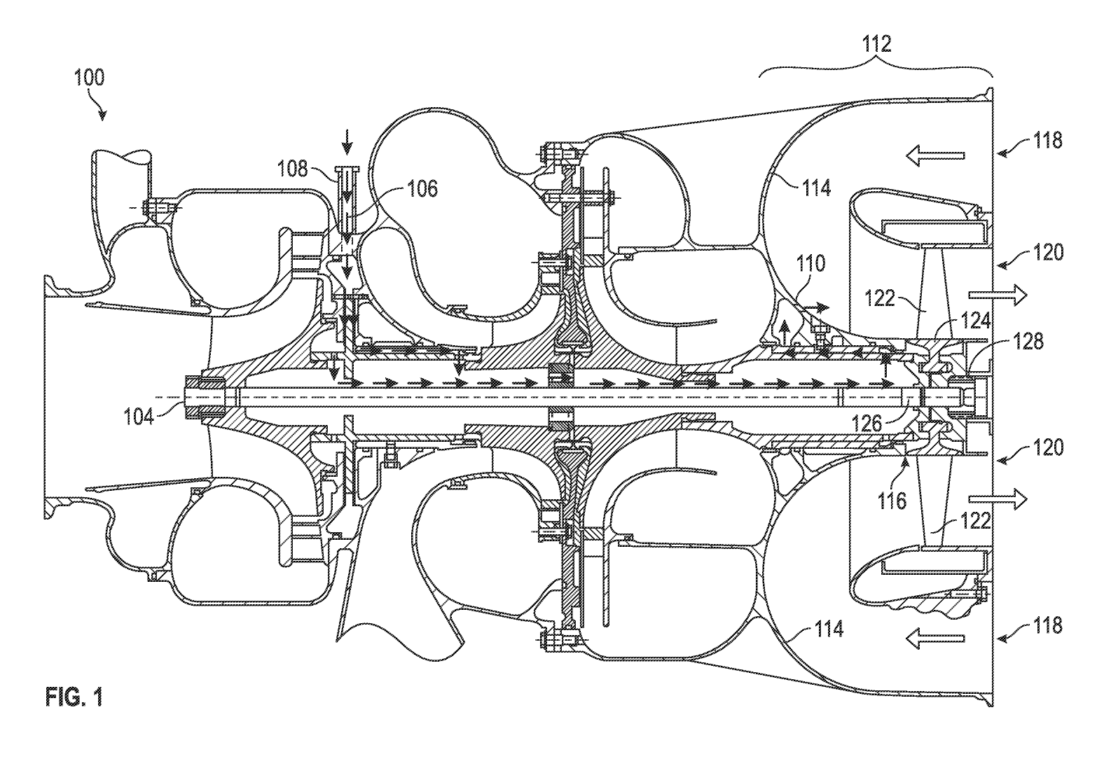

FIG. 1 illustrates an air cycle machine 100 is part of an environmental control system that is configured to supply conditioned air, for example, to a cabin of an aircraft. The air cycle machine 100 of FIG. 1 is a four-wheel air cycle machine, with four rotors on a shaft 104. The four rotors are fixed together and are supported by hydrodynamic bearing elements. There are, thus, four bearings configured within the air cycle machine 100 which are arranged along an airflow passage 106 that is represented by the path of arrows in FIG. 1. The air flow passage 106 provides air as both a lubricating fluid for the hydrodynamic bearings and as a cooling air flow to remove heat generated by the bearings during operation. Although described herein as a four-wheel air cycle machine, this is presented for illustrative and explanatory purposes, and other air cycle machines or other device/configurations may be used without departing from the scope of the invention, such as, for example, three-wheel air cycle machines.

Cooling air is passed through the air cycle machine 100 along an airflow passage 106 which is supplied from a cooling air inlet 108. The cooling air inlet 108 may be fluidly connected to an air supply source, which may be a single, high pressure, cool temperature source (not shown). For example, bearing cooling air may be bleed air from one of the environmental control system heat exchangers. After entering at the inlet 108, the cooling air passes through the air cycle machine 100 through airflow passage 106 and exits the airflow passage 106 at one or more apertures 110 into a fan section 112. The apertures 110 may be apertures that are formed or pass through a housing 114 for a fan 116, such as a fan of a compressor. Thus, the housing 114 may define, in part by means of apertures 110, an airflow path for the fan 116. In addition to the air entering the fan section 112 from the airflow path 106, a larger volume of air enters the housing 114 at a fan inlet 118. The air in the housing 114 that interacts with the fan 116 is thus supplied primarily by the fan inlet 118 with a portion passing into the housing 114 through the apertures 110. The combined air then exits the fan section 112 at an outlet 120.

The fan section 112 includes the fan 116 having fan blades 122, a fan rotor 124 to which the fan blades 122 are connected, fan shaft 126, and a tie rod 128. The fan rotor 124 is operably connected to the fan shaft 126.

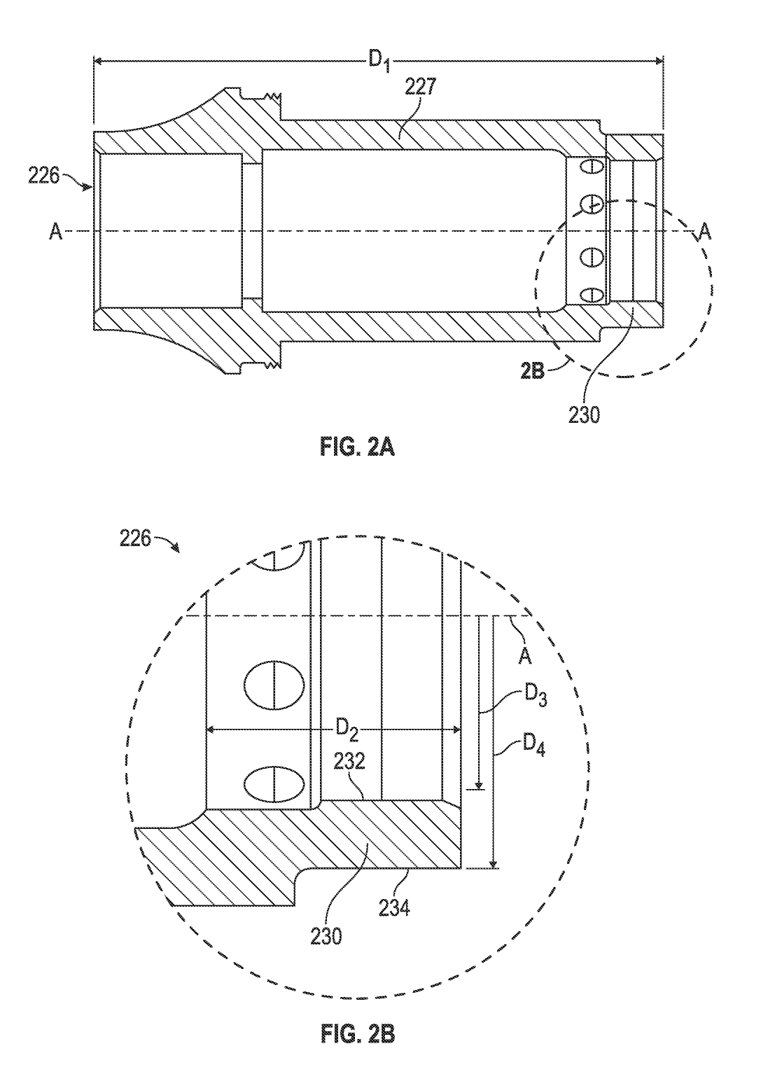

Turning now to FIG. 2A, a fan shaft 226 in accordance with an embodiment of the present disclosure is shown. Fan shaft 226 has a body 227 having an overall length of D₁, in an axial direction. As used herein, axial direction means along the axis A-A of the fan shaft 226. In some embodiments, the over length D₁ of the fan shaft 226 may be 4.215±0.005 inches (10.706±0.013 cm), and thus may range be between 4.210 inches (10.693 cm) and 4.220 inches (10.719 cm).

FIG. 2B is an enlarged view of a portion of the fan shaft 226 of FIG. 2A, as indicated by the circle 2B in FIG. 2A. The enlarged view is of a shaft shaft pilot 230. The shaft shaft pilot 230 is configured to engage with a fan rotor pilot.

As will be appreciated by those of skill in the art, the shaft pilot 230 may be configured as a circumferential ring or cylinder. The axis A-A may pass through a center of the shaft pilot 230, such that the pilot may have an axial length along the axis A-A and radial thicknesses with respect to the axis A-A, as described below.

As shown in FIG. 2, the pilot has an axial length D₂. In some embodiments, the axial length D₂ of the shaft pilot 230 may be 0.490±0.025 inches (1.245±0.064 cm). That is, the shaft pilot 230 may have an axial length D₂ between 0.465 inches (1.181 cm) and 0.515 inches (1.308 cm).

Further, as shown, the shaft pilot 230 may be configured with an inner diameter D₃. The inner diameter D₃ is a length across the pilot from a point on an interior surface 232 to an opposing point on the interior surface that extends through the axis A-A. In some embodiments, the inner diameter D₃ of the shaft pilot 230 may be 1.0991±0.0002 inches (2.7917±0.0005 cm). That is, the shaft pilot 230 may have an inner diameter D₃ between 1.0989 inches (2.7912 cm) and 1.0993 inches (2.7922 cm).

Moreover, as shown, the shaft pilot 230 may be configured with an outer diameter D₄. The outer diameter D₄ is a length across the pilot from a point on an outer surface 234 to an opposing point on the outer surface that extends through the axis A-A. In some embodiments, the outer diameter D₄ of the shaft pilot 230 may be 1.405±0.005 inches (3.569±0.013 cm). That is, the shaft pilot 230 may have an outer diameter D₄ between 1.400 inches (3.556 cm) and 1.410 inches (3.581 cm).

In some embodiments, rather than the absolute lengths described above, a pilot shaft may be configured such that various dimensions are related to each other. The following configurations will make reference to the overall length of the fan shaft D₁, the length of the pilot D₂, the inner diameter of the pilot D₃, and the outer diameter of the pilot D₄, as labeled and shown in FIGS. 2A and 2B.

Accordingly, in a first non-limiting example, a fan shaft may be formed having a ratio of the overall length of the fan shaft D₁ to the length of the pilot D₂. In some embodiments, the ratio of D₁/D₂ may be between 8.1748 and 9.0753.

In other non-limiting embodiments, a fan shaft may be formed having a ratio of the overall length of the fan shaft D₁ to the inner diameter D₃. In some embodiments, the ratio of D₁/D₃ may be between 3.8297 and 3.8402.

In other non-limiting embodiments, a fan shaft may be formed having a ratio of the overall length of the fan shaft D₁ to the outer diameter D₄. In some embodiments, the ratio of D₁/D₄ may be between 2.9858 and 3.0143.

In other non-limiting embodiments, a fan shaft may be formed having a ratio of the inner diameter D₃ to the pilot length D₂. In some embodiments, the ratio of D₃/D₂ may be between 2.1338 and 2.3641.

In other non-limiting embodiments, a fan shaft may be formed having a ratio of the inner diameter D₃ to the outer diameter D₄. In some embodiments, the ratio of D₃/D₄ may be between 0.7794 and 0.7852.

In other non-limiting embodiments, a fan shaft may be formed having a ratio of the pilot length D₂ to the outer diameter D₄. In some embodiments, the ratio of D₂/D₄ may be between 0.3298 and 0.3679.

Advantageously, embodiments described herein provide an optimized fan shaft for an air cycle machine that may retain proper fan trajectory during a rotor burst. Further, advantageously, embodiments described herein may provide for minimized stress in the fan shaft during operation.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A fan shaft for an air cycle machine, the fan shaft comprising:
a body having an axis passing therethrough and a pilot at one end of the body, the body having a first axial length, the pilot having a second axial length, and the pilot defining an inner diameter with respect to the axis and an outer diameter with respect to the axis,
wherein the first axial length is 4.215±0.005 inches (10.706±0.013 cm).

2. The fan shaft of claim 1, wherein the second axial length is 0.490±0.025 inches (1.245±0.064 cm).

3. The fan shaft of claim 1, wherein the inner diameter is 1.0991±0.0002 inches (2.7917±0.0005 cm).

4. The fan shaft of claim 1, wherein the outer diameter 1.405±0.005 inches (3.569±0.013 cm).

5. The fan shaft of claim 1, wherein a ratio between the first axial length and the second axial length is between 8.1748 and 9.0753.

6. The fan shaft of claim 1, wherein a ratio between the first axial length and the inner diameter is between 3.8297 and 3.8402.

7. The fan shaft of claim 1, wherein a ratio between the first axial length and the outer diameter is between 2.9858 and 3.0143.

8. The fan shaft of claim 1, wherein a ratio between the inner diameter and the second axial length is between 2.1338 and 2.3641.

9. The fan shaft of claim 1, wherein a ratio between the inner diameter and the outer diameter is between 0.7794 and 0.7852.

10. The fan shaft of claim 1, wherein a ratio between the second axial length and the outer diameter is 0.3298 and 0.3679.

11. A method of making a fan shaft for an air cycle machine, the method comprising:
Forming a body having an axis passing therethrough and a pilot at one end of the body, the body having a first axial length, the pilot having a second axial length, and the pilot defining an inner diameter with respect to the axis and an outer diameter with respect to the axis,
wherein the first axial length is 4.215±0.005 inches (10.706±0.013 cm).

12. The method of claim 11, wherein a ratio between the first axial length and the second axial length is between 8.1748 and 9.0753.

13. The method of claim 11, wherein a ratio between the first axial length and the inner diameter is between 3.8297 and 3.8402.

14. The method of claim 11, wherein a ratio between the first axial length and the outer diameter is between 2.9858 and 3.0143.

15. The method of claim 11, wherein a ratio between the inner diameter and the second axial length is between 2.1338 and 2.3641.

16. The method of claim 11, wherein a ratio between the inner diameter and the outer diameter is between 0.7794 and 0.7852.

17. The method of claim 11, wherein a ratio between the second axial length and the outer diameter is 0.3298 and 0.3679.

18. A fan shaft for an air cycle machine, the fan shaft comprising:
a body having an axis passing therethrough and a pilot at one end of the body, the body having a first axial length, the pilot having a second axial length, and the pilot defining an inner diameter with respect to the axis and an outer diameter with respect to the axis,
wherein a ratio between the first axial length and the second axial length is between 8.1748 and 9.0753.

19. The fan shaft of claim 18, wherein a ratio between the second axial length and the outer diameter is 0.3298 and 0.3679.

20. The fan shaft of claim 18, wherein the first axial length is 4.215±0.005 inches (10.706±0.013 cm).
